(19) United States
(12) Patent Application Publication
(10) Pub. No.: US 2016/0326943 A1
(43) Pub. Date: Nov. 10, 2016

(54) COOLING CONTROL APPARATUS FOR INTERNAL COMBUSTION ENGINE AND INTERNAL COMBUSTION ENGINE

(71) Applicant: HONDA MOTOR CO., LTD., Tokyo (JP)

(72) Inventors: Noritaka KIMURA, Wako (JP); Yosuke YAMADA, Wako (JP); Kosuke IHARA, Wako (JP); Hajime UTO, Wako (JP); Yoshikazu TANAKA, Wako (JP)

(73) Assignee: HONDA MOTOR CO., LTD., Tokyo (JP)

(21) Appl. No.: 15/086,060

(22) Filed: Mar. 31, 2016

(30) Foreign Application Priority Data
May 8, 2015 (JP) 2015-095789

(51) Int. Cl. F01P 7/16; F02B 29/04; F02B 63/04; F01P 5/12

(52) U.S. Cl. CPC F01P 7/167; F01P 7/165; F01P 5/12; F02B 29/0443; F02B 63/04; F01P 2005/105

(57) ABSTRACT

A cooling control apparatus for an internal combustion engine with a supercharger includes an internal combustion engine cooling circuit, an inhaled gas cooling circuit, a cooling water introducing passage, an overcooling determination device, and a temperature-decrease controller. The overcooling determination device is to determine whether the internal combustion engine is overcooled based on a decrease in temperature of cooling water in the internal combustion engine cooling circuit. The temperature-decrease controller is to control an amount of the cooling water flowing from the internal combustion engine cooling circuit to the inhaled gas cooling circuit via the cooling water introducing passage to control the decrease in the temperature of the cooling water in the internal combustion engine cooling circuit in a case where the overcooling determination device determines that the internal combustion engine is overcooled.

### CROSS-REFERENCE TO RELATED APPLICATIONS

The present application claims priority under 35 U.S.C. §119 to Japanese Patent Application No. 2015-095789, filed May 8, 2015, entitled “Cooling Control Apparatus for Internal Combustion Engine.” The contents of this application are incorporated herein by reference in their entirety.

### BACKGROUND

1. Field

The present disclosure relates to a cooling control apparatus for an internal combustion engine and an internal combustion engine.

2. Description of the Related Art

One known example of cooling control apparatuses for internal combustion engines is disclosed in Japanese Unexamined Patent Application Publication No. 2014-156804. This exemplary cooling control apparatus includes: an engine cooling circuit that cools an internal combustion engine; and an inhaled gas cooling circuit that cools inhaled gas by using an intercooler.

The above engine cooling circuit has a cooling water passage and a mechanical pump; the cooling water passage is connected to both the internal combustion engine and a radiator for a high-temperature system, and the mechanical pump is driven by the internal combustion engine. The cooling water passage contains cooling water having a relatively high temperature (referred to below as “high-temperature cooling water”). This high-temperature cooling water circulates through the cooling water passage, thereby cooling the internal combustion engine. The above inhaled gas cooling circuit has an electrically powered pump and a cooling water passage connected to both the intercooler and a radiator for a low-temperature system. The cooling water passage contains cooling water having a relatively low temperature (referred to below as “low-temperature cooling water”). This low-temperature cooling water circulates through the cooling water passage, thereby cooling the inhaled gas through the intercooler. Further, the cooling water passage in the engine cooling circuit is connected to the cooling water passage in the inhaled gas cooling circuit via two passages, each of which has a valve.

The internal combustion engine is provided with an EGR apparatus; the EGR apparatus returns part of an exhaust gas (referred to below as an “EGR gas”) to an intake passage at a location upstream from a compressor of the supercharger. Therefore, during the EGR, an inhaled gas that contains a mixture of inhaled air and the EGR gas is supplied to the intake passage by the supercharger, then cooled by the intercooler, and inhaled into the internal combustion engine. In this case, the EGR gas contains a relatively large quantity of vapor, and this vapor may condense if the inhaled gas is overcooled by the intercooler. Further, the resultant condensate water might come into contact with the intercooler and other components in the inhalation system, for example, disadvantageously corroding these components.

To avoid the disadvantages described above, the cooling control apparatus detects a temperature of the outlet of the intercooler and determines a dew-point temperature of the inhaled gas. Then, the cooling control apparatus opens the valves in the two connection passages when the outlet temperature of the intercooler is equal to or lower than the determined dew-point temperature. In response to this, the high-temperature cooling water in the engine cooling circuit is introduced to the inhaled gas cooling circuit via the connection passages. Then, the high-temperature cooling water is mixed with the low-temperature cooling water, increasing the temperature of the low-temperature cooling water. In this way, the inhaled gas is kept at a temperature higher than its dew-point temperature, thereby reducing generation of condensate water, or condensation of the inhaled gas.

### SUMMARY

According to one aspect of the present invention, a cooling control apparatus for an internal combustion engine which cools an internal combustion engine equipped with a supercharger and which cools inhaled gas supplied from the supercharger by using an intercooler includes an internal combustion engine cooling circuit, an inhaled gas cooling circuit, a cooling water introducing passage, an overcooling determination unit, and a temperature-decrease controller. The internal combustion engine cooling circuit includes an internal combustion engine main body, a first radiator, a first cooling water passage, and a first pump. The first cooling water passage is connected to the internal combustion engine main body and to the first radiator. The first cooling water passage allows cooling water to circulate between the internal combustion engine main body and the first radiator. The first pump causes the cooling water to circulate by feeding the cooling water to the first cooling water passage. The inhaled gas cooling circuit includes the intercooler, a second radiator, a second cooling water passage, and a second pump. The second cooling water passage is connected to the intercooler and to the second radiator. The second cooling water passage allows cooling water to circulate between the intercooler and the second radiator. The second pump causes the cooling water to circulate by feeding the cooling water to the second cooling water passage. The cooling water introducing passage is connected to the first cooling water passage and to the second cooling water passage. The cooling water introducing passage allows the cooling water in the internal combustion engine cooling circuit to be introduced to the inhaled gas cooling circuit. The overcooling determination unit determines whether the internal combustion engine is overcooled due to a decrease in temperature of the cooling water in the internal combustion engine cooling circuit. The temperature-decrease controller, when the overcooling determination unit determines that the internal combustion engine is overcooled, controls the decrease in the temperature of the cooling water in the internal combustion engine cooling circuit.

According to another aspect of the present invention, a cooling control apparatus for an internal combustion engine with a supercharger includes an internal combustion engine cooling circuit, an inhaled gas cooling circuit, a cooling water introducing passage, an overcooling determination device, and a temperature-decrease controller. The internal combustion engine cooling circuit includes a first radiator, a first cooling water passage, and a first pump. The first cooling water passage connects the first radiator to a main body of the internal combustion engine. The first pump is provided in the first cooling water passage to circulate cooling water in the internal combustion engine cooling circuit. The inhaled gas cooling circuit includes an intercooler, a second radiator, a second cooling water passage, and a second pump. The intercooler is to cool inhaled gas supplied from the supercharger. The second cooling water passage connects the second radiator to the intercooler. The second pump is provided in the second cooling water passage to circulate cooling water in the inhaled gas cooling circuit. The cooling water introducing passage connects the first cooling water passage and the second cooling water passage. The cooling water flows from the internal combustion engine cooling circuit to the inhaled gas cooling circuit via the cooling water introducing passage. The overcooling determination device is to determine whether the internal combustion engine is overcooled based on a decrease in temperature of the cooling water in the internal combustion engine cooling circuit. The temperature-decrease controller is to control an amount of the cooling water flowing from the internal combustion engine cooling circuit to the inhaled gas cooling circuit via the cooling water introducing passage to control the decrease in the temperature of the cooling water in the internal combustion engine cooling circuit in a case where the overcooling determination device determines that the internal combustion engine is overcooled.

According to further aspect of the present invention, an internal combustion engine includes a main body, a supercharger, an internal combustion engine cooling circuit, an inhaled gas cooling circuit, a cooling water introducing passage, an overcooling determination device, and a temperature-decrease controller. The internal combustion engine cooling circuit includes a first radiator, a first cooling water passage, and a first pump. The first cooling water passage connects the first radiator to the main body of the internal combustion engine. The first pump is provided in the first cooling water passage to circulate cooling water in the internal combustion engine cooling circuit. The inhaled gas cooling circuit includes an intercooler, a second radiator, a second cooling water passage, and a second pump. The intercooler is to cool inhaled gas supplied from the supercharger. The second cooling water passage connects the second radiator to the intercooler. The second pump is provided in the second cooling water passage to circulate cooling water in the inhaled gas cooling circuit. The cooling water introducing passage connects the first cooling water passage and the second cooling water passage. The cooling water flows from the internal combustion engine cooling circuit to the inhaled gas cooling circuit via the cooling water introducing passage. The overcooling determination device is to determine whether the internal combustion engine is overcooled based on a decrease in temperature of the cooling water in the internal combustion engine cooling circuit. The temperature-decrease controller is to control an amount of the cooling water flowing from the internal combustion engine cooling circuit to the inhaled gas cooling circuit via the cooling water introducing passage to control the decrease in the temperature of the cooling water in the internal combustion engine cooling circuit in a case where the overcooling determination device determines that the internal combustion engine is overcooled.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 schematically illustrates a configuration of an internal combustion engine in one embodiment.

FIG. 2 is a schematic block diagram of a cooling control apparatus in one embodiment.

FIG. 3 schematically illustrates a configuration of an engine cooling circuit and an inhaled gas cooling circuit.

FIG. 4A illustrates flows of cooling water in both the engine cooling circuit and the inhaled gas cooling circuit when the introducing valve is opened, and FIG. 4B illustrates flows of cooling water in both the engine cooling circuit and the inhaled gas cooling circuit when the introducing valve is closed.

FIG. 5 is a flowchart of a cooling control process in a first embodiment.

FIG. 6 is a map for use in determining within which of operation ranges, including a first water temperature range, the internal combustion engine falls.

FIG. 7 is a graph for use in calculating the target for a temperature of low-temperature cooling water.

FIG. 8 is a map for use in calculating the lower limit of the quantity of cooling water fed by electrically powered pump.

FIG. 9 is a graph showing a relationship between the quantity of head transferred from the engine cooling circuit to the inhaled gas cooling circuit and a threshold of the heat quantity.

FIG. 10 is a flowchart of a cooling control process in a second embodiment.

### DESCRIPTION OF THE EMBODIMENTS

The embodiments will now be described with reference to the accompanying drawings, wherein like reference numerals designate corresponding or identical elements throughout the various drawings.

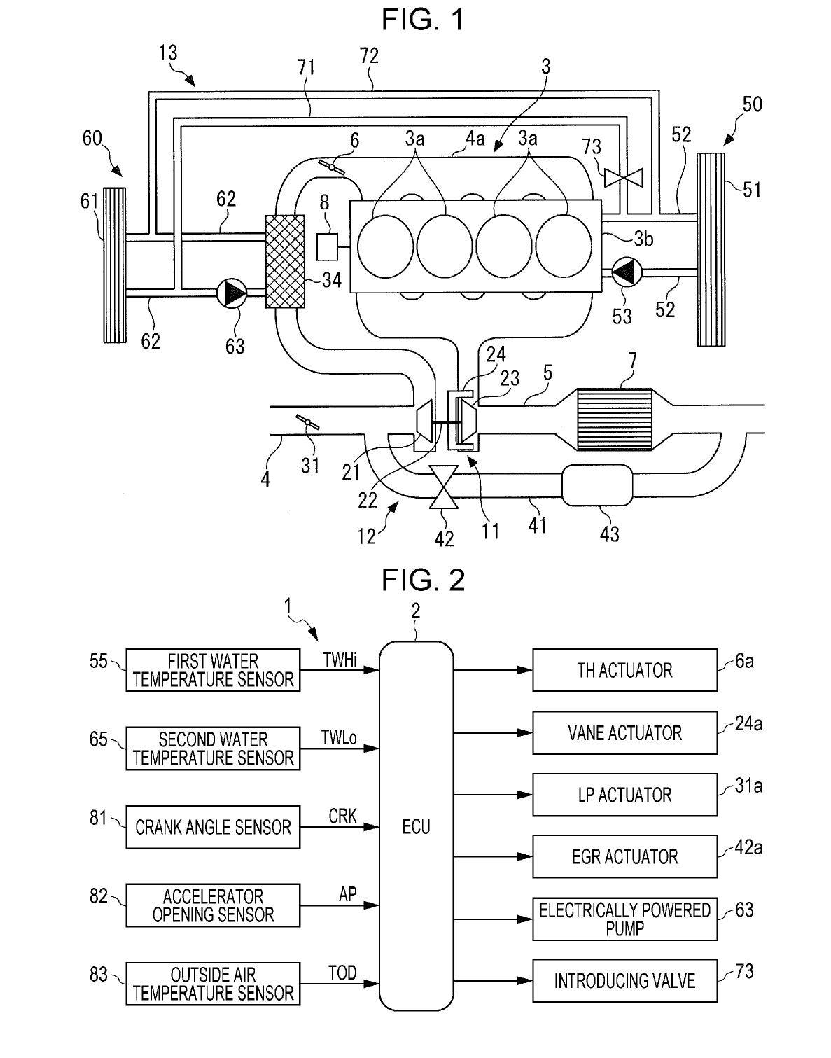

Some embodiments will be described in detail below, with reference to the accompanying drawings. FIG. 1 schematically illustrates a configuration of an internal combustion engine (referred to below as an “engine”) 3 that includes a cooling control apparatus 1. FIG. 2 is a schematic block diagram of the cooling control apparatus 1. The engine 3 may be, for example, a gasoline-powered engine having four cylinders 3a and mounted in a vehicle (not illustrated) as a mechanical power source. The engine 3 is coupled to an electric generator 8 that generates electric power by using the engine 3 as a mechanical power source. The electrical energy generated by the electric generator 8 is controlled in accordance with a control signal transmitted from an ECU 2 (described later), and stored in a battery (not illustrated).

The engine 3 includes a turbocharger 11, an EGR apparatus 12, and a cooling apparatus 13.

The turbocharger 11 includes a compressor 21 and a turbine 23; the compressor 21 is disposed in an intake passage 4, and the turbine 23 is disposed in an exhaust passage 5 and integrally coupled to the compressor 21 through a shaft 22. An exhaust gas that flows through the exhaust passage 5 rotates the turbine 23. Then, the compressor 21 that rotates together with the turbine 23 exerts pressure on an inhaled gas, feeding the inhaled gas to the cylinders 3a.

The turbocharger 11 may be provided with a variable vane 24 that can rotate to vary a supercharging pressure. In this case, the opening of variable vane 24 is controlled in accordance with a control signal transmitted from the ECU 2 via a vane actuator 24a.

In the intake passage 4, an intake throttle valve 31, the compressor 21 in the turbocharger 11, an intercooler 34 in the cooling apparatus 13, and a throttle valve 6 are disposed in this order in the downstream direction. The intake throttle valve 31 generates a relatively low negative pressure in order to stably blow an EGR gas in the downstream direction. The opening of the intake throttle valve 31 is controlled in accordance with a control signal transmitted from ECU 2 via an LP actuator 31a.

The intercooler 34 may be a water-cooled type cooler, and exchanges heat between the inhaled gas supplied and heated by the compressor 21 in the turbocharger 11 and cooling water flowing through the intercooler 34, thereby cooling the inhaled gas.

The throttle valve 6 is rotatable and disposed in the intake passage 4 at a location upstream from an intake manifold 4a. The opening of the throttle valve 6 is controlled in accordance with a control signal transmitted from the ECU 2 via a TH actuator 6a. With this control, the quantity of inhaled gas supplied to the cylinders 3a in the engine 3 is adjusted.

Catalysis 7 is disposed in the exhaust passage 5 at a location downstream from the turbine 23. The catalysis 7 may be ternary compound catalysis, for example, and cleans the exhaust gas by oxidizing HC or CO and chemically reducing NOx in the exhaust gas flowing through the exhaust passage 5.

The EGR apparatus 12 returns part of the exhaust gas discharged to the exhaust passage 5 to the intake passage 4 as an EGR gas. The EGR apparatus 12 includes an EGR passage 41, an EGR valve 42, and an EGR cooler 43. The EGR passage 41 is connected to the intake passage 4 at a location upstream from compressor 21 and to the exhaust passage 5 at a location downstream from catalysis 7.

The opening of the EGR valve 42 is controlled in accordance with a control signal transmitted from the ECU 2 via an EGR actuator 42a. With this control, the quantity of EGR gas returned from exhaust passage 5 to the intake passage 4 is adjusted. The EGR cooler 43 is disposed in the EGR passage 41 at a location upstream from the EGR valve 42 (closer to the exhaust passage 5 than the EGR valve 42). The EGR cooler 43 cools the EGR gas having a high temperature by using cooling water in an engine cooling circuit 50 (described later) in the cooling apparatus 13.

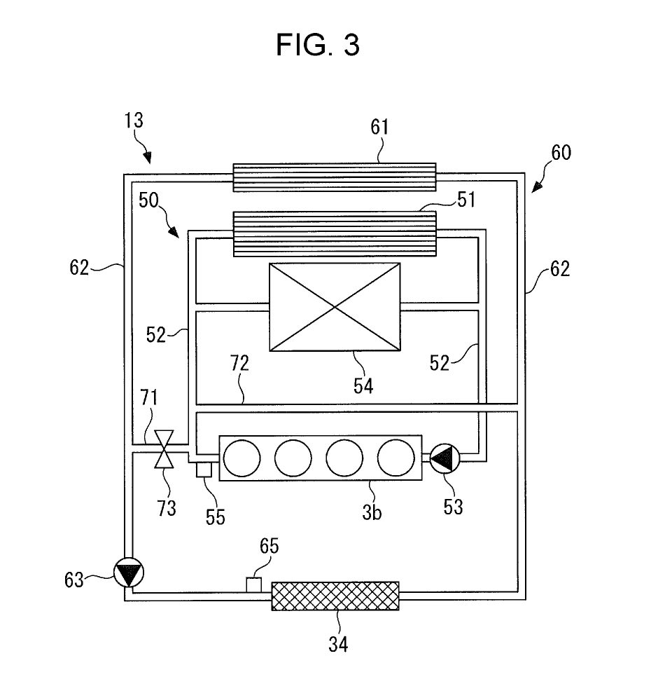

As illustrated in FIG. 1 and FIG. 3, the cooling apparatus 13 is provided with the engine cooling circuit 50 and an inhaled gas cooling circuit 60; the engine cooling circuit 50 cools an engine main body 3b in the engine 3, and the inhaled gas cooling circuit 60 cools the inhaled gas by using the intercooler 34.

The engine cooling circuit 50 is provided with the engine main body 3b, a main radiator 51, a first cooling water passage 52 having a ring shape, and a mechanical pump 53; the first cooling water passage 52 is connected to both the engine main body 3b and the main radiator 51 and filled with cooling water, and the mechanical pump 53 is driven by the engine 3.

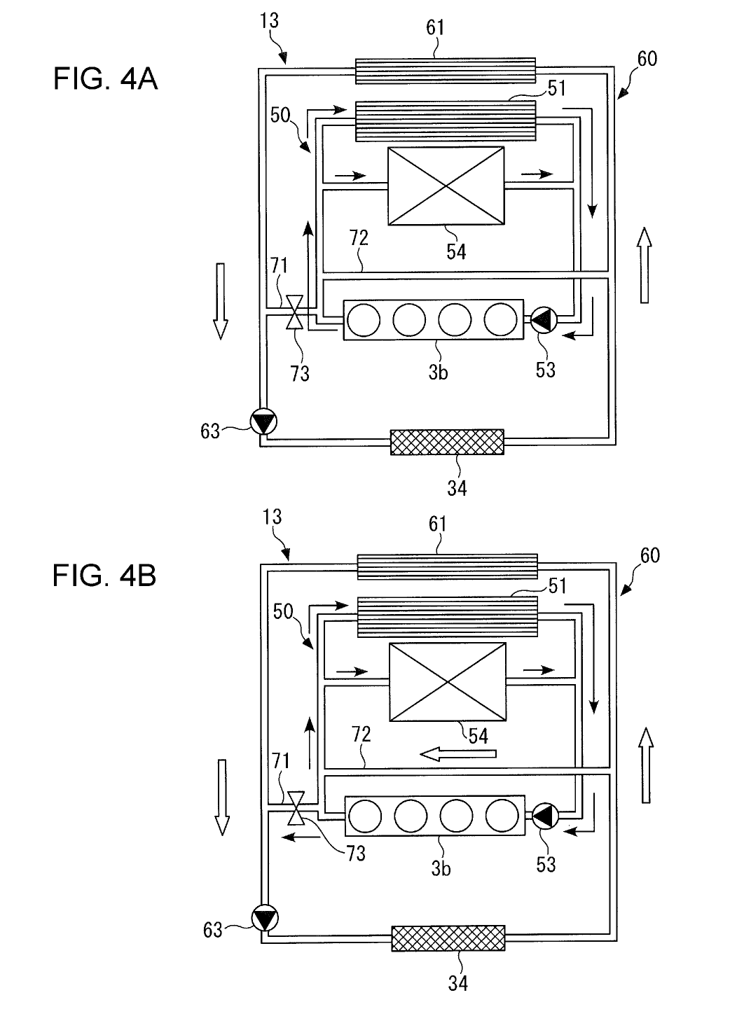

As illustrated in FIG. 4A and FIG. 4B, in the engine cooling circuit 50, the mechanical pump 53 feeds the cooling water to the cylinders 3a during an operation of the engine 3. The cooling water thereby flows and circulates through the first cooling water passage 52 in the clockwise direction (in the direction of the thin arrows) in FIG. 4A and FIG. 4B. The cooling water circulating in this manner removes heat from the engine main body 3b when passing through the engine main body 3b, thereby cooling the engine 3. Then, the cooling water radiates the removed heat through the main radiator 51 when passing through the main radiator 51. Since the engine 3 produces combustion heat, the engine main body 3b typically has a high temperature. Therefore, the cooling water flowing in the engine cooling circuit 50 also has a relatively high temperature. Hereinafter, this cooling water is referred to as “high-temperature cooling water”.

The temperature (referred to below as a “high cooling water temperature”) TWHi of the above high-temperature cooling water is detected by a first water temperature sensor 55 (see FIG. 3); the first water temperature sensor 55 is disposed in the first cooling water passage 52 at a predetermined location, such as at a location immediately downstream from the engine main body 3b. The first water temperature sensor 55 outputs the detection signal to the ECU 2. As illustrated in FIG. 3, the first cooling water passage 52 is connected to various auxiliary machines 54, for example, including the turbocharger 11, the EGR cooler 43, and a throttle body (not illustrated) accommodating the throttle valve 6. Thus, the high-temperature cooling water is also used to cool these auxiliary machines 54.

The inhaled gas cooling circuit 60 is provided with the intercooler 34, a sub-radiator 61, a second cooling water passage 62, and an electrically powered pump 63; the second cooling water passage 62, which has a ring shape, is connected to both the intercooler 34 and the sub-radiator 61 and filled with cooling water.

As illustrated in FIG. 4A and FIG. 4B, in the inhaled gas cooling circuit 60, the electrically powered pump 63 feeds the cooling water to the intercooler 34. The cooling water thereby flows and circulates through the second cooling water passage 62 in the counterclockwise direction (in the direction of the thick arrows) in FIG. 4A and FIG. 4B. The cooling water circulating in this manner removes heat from the inhaled gas flowing through the intercooler 34 when passing through the intercooler 34, thereby cooling the inhaled gas. Then, the cooling water radiates the removed heat through the sub-radiator 61 when passing through the sub-radiator 61. This inhaled gas typically has a lower temperature than the engine main body 3b. Therefore, the cooling water flowing through the inhaled gas cooling circuit 60 has a lower temperature than the high-temperature cooling water. Hereinafter, this cooling water is referred to as “low-temperature cooling water”.

The temperature (referred to below as a “low cooling water temperature”) TWLo of the above low-temperature cooling water is detected by a second water temperature sensor 65 (see FIG. 3); the second water temperature sensor 65 is disposed in the second cooling water passage 62 at a predetermined location, such as at a location immediately upstream from the intercooler 34. The second water temperature sensor 65 outputs the detection signal to the ECU 2.

As illustrated in FIG. 3, the first cooling water passage 52 is connected to the second cooling water passage 62 via a high-temperature cooling water introducing passage 71 and a low-temperature cooling water returning passage 72.

The high-temperature cooling water introducing passage 71 is connected to the first cooling water passage 52 at a location immediately downstream from the engine main body 3b and connected to the second cooling water passage 62 at a location downstream from the sub-radiator 61 and upstream from the electrically powered pump 63. The high-temperature cooling water introducing passage 71 is provided with an introducing valve 73. The introducing valve 73 has two positions; in the first position, the introducing valve 73 is fully opened, and in the second position, the introducing valve 73 is fully closed. Switching between the first and second positions is controlled in accordance with a control signal transmitted from the ECU 2.

The low-temperature cooling water returning passage 72 is connected to the second cooling water passage 62 at a location downstream from the intercooler 34 and upstream from the sub-radiator 61. In addition, the low-temperature cooling water returning passage 72 is connected to the first cooling water passage 52 at a location upstream from the connection node between the first cooling water passage 52 and the high-temperature cooling water introducing passage 71 and at a location upstream from both the main radiator 51 and the auxiliary machines 54.

With the above configuration, the mechanical pump 53 and the electrically powered pump 63 are operated. When the introducing valve 73 is closed, the cooling water in the engine cooling circuit 50 does not flow into the inhaled gas cooling circuit 60 and the cooling water in the inhaled gas cooling circuit 60 does not flow into the engine cooling circuit 50. More specifically, as illustrated in FIG. 4A, the high-temperature cooling water in the engine cooling circuit 50 circulates in the clockwise direction (in the direction of the thin arrows), whereas the low-temperature cooling water in the inhaled gas cooling circuit 60 circulates in the counterclockwise direction (in the direction of the thick arrows).

When the introducing valve 73 is opened, the high-temperature cooling water in the engine cooling circuit 50 and the low-temperature cooling water in the inhaled gas cooling circuit 60 also circulate in the above manner. In addition to this, as illustrated in FIG. 4B, part of the high-temperature cooling water in the engine cooling circuit 50 is introduced to the inhaled gas cooling circuit 60 through the high-temperature cooling water introducing passage 71. In this case, the part of the high-temperature cooling water is mixed with the low-temperature cooling water. As a result, heat of the high-temperature cooling water is transferred to the low-temperature cooling water, and the temperature of the low-temperature cooling water thereby increases. To compensate for the part of the high-temperature cooling water which has been introduced to the inhaled gas cooling circuit 60, part of the low-temperature cooling water in the inhaled gas cooling circuit 60 is introduced to the engine cooling circuit 50 through the low-temperature cooling water returning passage 72.

The engine 3 is provided with the crank angle sensor 81 (see FIG. 2). This crank angle sensor 81 outputs a CRK signal in pulse form to the ECU 2 every time a crank shaft (not illustrated) rotates at a predetermined crank angle, such as at an angle of 30 degrees. On the basis of the CRK signal, the ECU 2 calculates a rotation frequency (referred to below as an “engine rotation frequency”) NE of the engine 3. The ECU 2 receives a detection signal from an accelerator opening sensor 82 that indicates the degree to which the accelerator pedal (not illustrated) of the vehicle is stepped (referred to below as an “accelerator opening AP”). In addition, the ECU 2 receives a detection signal from an outside air temperature sensor 83 that indicates an outside air temperature TOD.

The ECU 2 may be a microprocessor including a CPU, RAM, ROM, and an I/O interface, all of which are not illustrated in the drawings. The ECU 2 performs a cooling control process in accordance with a predetermined control program and on the basis of the detection signals from the above sensors, for example. In this cooling control process, the ECU 2 controls the flows and temperatures of the low-temperature cooling water and the high-temperature cooling water by using the electrically powered pump 63 and the introducing valve 73. Herein, the ECU 2 corresponds to an overcooling determination unit and a temperature-decrease controller.

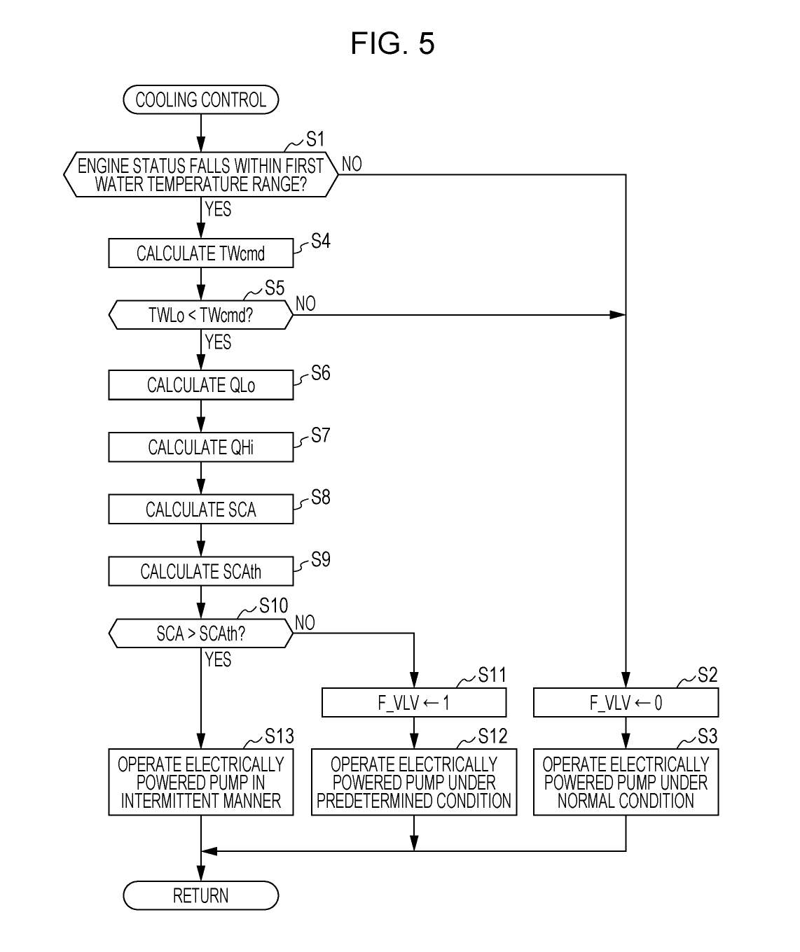

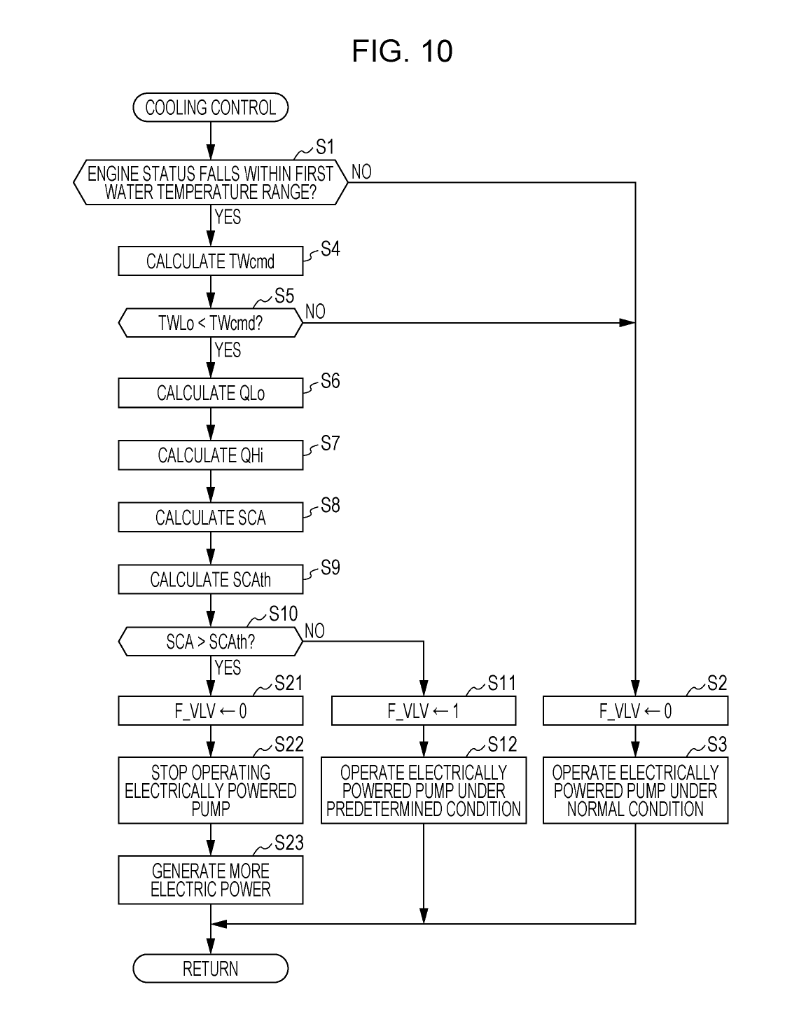

FIG. 5 is a flowchart of a cooling control process in a first embodiment. This cooling control process is performed at preset time intervals. First, at Step 1, the engine 3 determines whether to increase the temperature of the low-temperature cooling water, or whether the status of the engine 3 falls within a first water temperature range. It should be noted that Steps 1 to 23 described herein correspond to “S1” to “S23”, respectively, in FIG. 5 and FIG. 10).

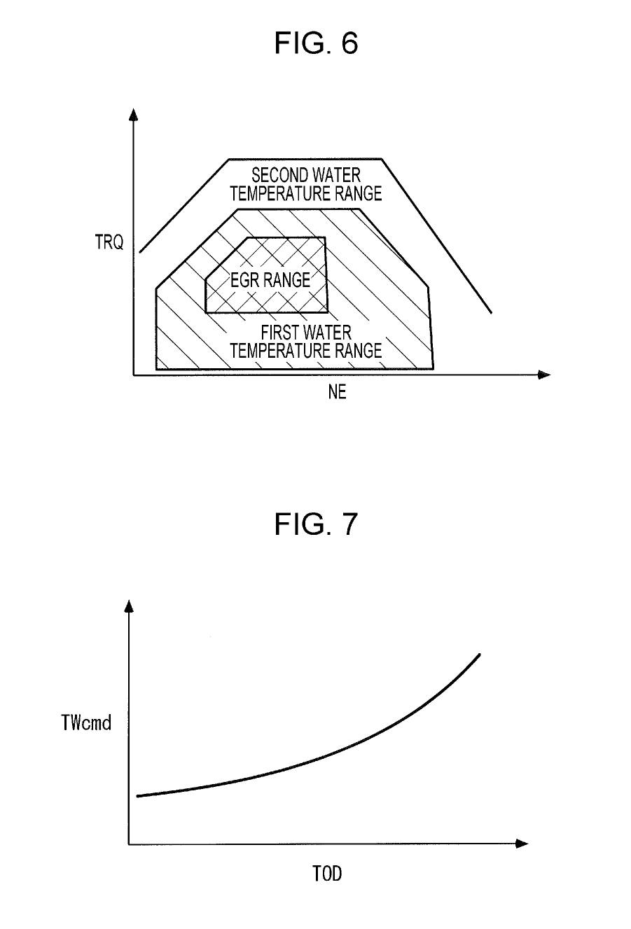

The above determination is made on the basis of a result of referring to an operation range map of the engine 3 illustrated in FIG. 6. In the operation range map, an operation range of the engine 3 which is defined by the engine rotation frequency NE and a required torque TRQ is classified into three ranges, more specifically, an EGR range in which the EGR is to be performed, the above first water temperature range, and a second water temperature range in which the temperature of the low-temperature cooling water is not to be increased.

In the operation range map, the first water temperature range corresponds to a range in which the engine rotation frequency NE and the required torque TRQ each have a low to middle value. In this first water temperature range, the turbocharger 11 supplies (compresses) a small quantity of inhaled gas, and thus the inhaled gas having a low temperature flows through the intercooler 34. Therefore, the inhaled gas cooled by the intercooler 34 is prone to condense. The EGR range is contained in the first water temperature range. Therefore, when the EGR is performed, the status of the engine 3 is determined to fall within the first water temperature range. Here, the required torque TRQ may be calculated on the basis of both the engine rotation frequency NE and the accelerator opening AP.

If the determination result is “NO” at Step 1, more specifically if the status of the engine 3 does not fall outside the first water temperature range but falls within the second water temperature range, the ECU 2 determines that it is not necessary to increase the temperature of the low-temperature cooling water. Then, at Step 2, the ECU 2 sets a valve opening flag F_VLV to “0”. At Step 3, the ECU 2 closes the introducing valve 73 and operates the electrically powered pump 63 under a normal condition. After that, the ECU 2 terminates the cooling control process. The operation of the electrically powered pump 63 under the normal condition corresponds to a continuous operation of the electrically powered pump 63. During the normal operation, the low-temperature cooling water circulates through the inhaled gas cooling circuit 60.

If the determination result is “YES” at Step 1, more specifically if the status of the engine 3 falls within the first water temperature range, the ECU 2 calculates a target water temperature TWcmd at Step 4; the target water temperature TWcmd is a target for a temperature of the low-temperature cooling water. The target water temperature TWcmd may be calculated on the basis of the outside air temperature TOD, an outside air humidity (or the absolute amount of moisture determined from an outside air temperature and a humidity), and an EGR rate. FIG. 7 is an exemplary graph for use in calculating the target water temperature TWcmd. In this graph, an outside air humidity and an EGR rate each have a constant value. The curve in this graph is based on the relationship between a temperature (outside air temperature) and a dew point. As the outside air temperature TOD increases, the target water temperature TWcmd needs to be set to a higher value.

At Step 5, the ECU 2 determines whether the low cooling water temperature TWLo detected by the second water temperature sensor 65 is less than the target water temperature TWcmd. If the determination result is “NO”, more specifically if TWLo≧TWcmd, the ECU 2 determines that it is not necessary to increase the temperature of the low-temperature cooling water, because the temperature of the low-temperature cooling water is high enough. So, the ECU 2 performs Steps 2 and 3, and then terminates the cooling control process.

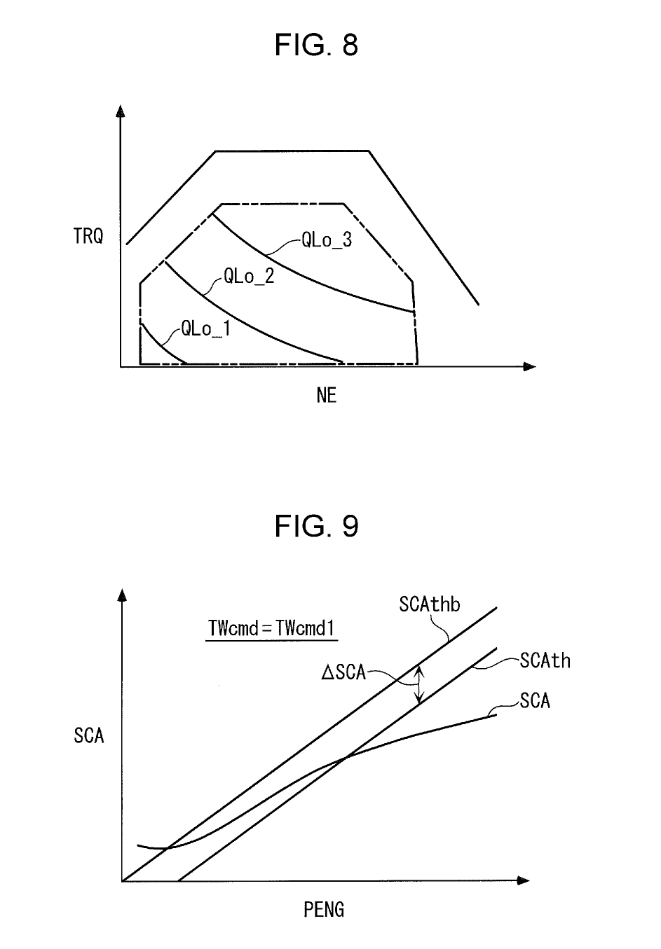

If the determination result is “YES” at Step 5, the ECU 2 calculates a low-limit feeding quantity QLo at Step 6. The low-limit feeding quantity QLo refers to the minimum quantity of low-temperature cooling water to be fed by the electrically powered pump 63, which makes it possible to sufficiently cool the inhaled gas, thereby reducing an occurrence of knocking in the engine 3. The low-limit feeding quantity QLo may be determined by reference to the map illustrated in FIG. 8 which is defined by the engine rotation frequency NE and the required torque TRQ.

In the map illustrated in FIG. 8, three lines indicating feeding quantities QLo_1, QLo_2, and QLo_3 (QLo_1<QLo_2<QLo_3) are set within a region defined by an alternate long and two short dashes line which corresponds to the first water temperature range in FIG. 6. As can be seen from the relationship of these lines, the temperature of the inhaled gas supplied to the inhaled gas cooling circuit 60 increases as the engine rotation frequency NE and the required torque TRQ increase. Therefore, as the engine rotation frequency NE and the required torque TRQ increase, the low-limit feeding quantity QLo is set to a larger value. If a value determined on the basis of the engine rotation frequency NE and the required torque TRQ is present on none of the three lines, the low-limit feeding quantity QLo may be calculated using an interpolation.

At Step 7, the engine 3 calculates an introduction quantity QHi, which is the quantity of high-temperature cooling water to be introduced from the engine cooling circuit 50 to the inhaled gas cooling circuit 60. The introduction quantity QHi may be calculated using equation (1),

QHi=(TWcmd−TWLo)/(TWHi−TWcmd)·QLo (1)

where TWcmd denotes the target water temperature detected at Step 4, QLo denotes the low-limit feeding quantity detected at Step 6, TWHi denotes the high cooling water temperature detected by the first water temperature sensor 55, and TWLo denotes the low cooling water temperature detected by the second water temperature sensor 65.

As understood from equation (1), the introduction quantity QHi is proportional to the low-limit feeding quantity QLo and the difference (TWcmd−TWLo) between the target water temperature TWcmd and the low cooling water temperature TWLo. In addition, the introduction quantity QHi is inversely proportional to the difference between the high cooling water temperature TWHi and the target water temperature TWcmd (TWHi−TWcmd).

At Step 8, the ECU 2 calculates a heat transfer quantity SCA. The heat transfer quantity SCA refers to the quantity of heat which is estimated to be transferred from the engine cooling circuit 50 to the inhaled gas cooling circuit 60 when the high-temperature cooling water in the engine cooling circuit 50 is introduced to the inhaled gas cooling circuit 60. For example, the heat transfer quantity SCA may be calculated using equation (2),

SCA=KTH·QLo·(TWcmd−TWLo) (2)

where QLo denotes the low-limit feeding quantity, TWcmd denotes the target water temperature, TWLo denotes the low cooling water temperature, and KTH denotes a scaling factor used to convert (flow rate×temperature difference) into (heat quantity).

Referring to the graph in FIG. 9, the curve denoted by the heat transfer quantity SCA represents the relationship between an output PENG of the engine 3 (referred to below as an “engine output”) and an exemplary heat transfer quantity SCA calculated using equation (2) under the condition of (target water temperature TWcmd=preset value TWcmd1). The engine output PENG may be, for example, the product of the required torque TRQ and the engine rotation frequency NE.

As indicated by the curve of the heat transfer quantity SCA in the graph of FIG. 9, as the engine output PENG increases, the heat transfer quantity SCA calculated in the above manner increases. This is because as the engine output PENG increases, the quantity of heat emitted from the engine 3 increases. In other words, as the engine output PENG increases, the temperature of the high-temperature cooling water increases. In response to this, the difference between the high-temperature cooling water and the low-temperature cooling water increases. Furthermore, as the engine output PENG increases, the temperature of the inhaled gas supplied to the inhaled gas cooling circuit 60 increases. So, when the intercooler 34 cools the inhaled gas, heat transferred from the inhaled gas to the low-temperature cooling water increases. In response to this, the temperature of the low-temperature cooling water increases, so that the difference in temperature between the low-temperature cooling water and the target water temperature TWcmd decreases. As a result, the calculated heat transfer quantity SCA has a lower gradient at a higher engine output PENG.

Referring back to FIG. 5, at Step 9 following Step 8, the ECU 2 calculates a threshold SCAth of the heat transfer quantity SCA. The threshold SCAth refers to the upper limit of the quantity of heat that can be transferred from the engine cooling circuit 50 to the inhaled gas cooling circuit 60 without overcooling the engine 3. Thus, if the heat transfer quantity SCA exceeds the threshold SCAth, the engine 3 may be overcooled.

The threshold SCAth is calculated by subtracting a compensation value ΔSCA from a basic value SCAthb. For example, the threshold SCAth may be calculated using equation (3).

SCAth=SCAthb−ΔSCA (3)

The basic value SCAthb calculated by multiplying the engine output PENG by a preset coefficient. Thus, the basic value SCAthb is proportional to the engine output PENG, as indicated by the graph of FIG. 9. A reason for this is that the engine 3 emits higher heat at a higher engine output PENG. The compensation value ΔSCA is used to compensate for heat of the high-temperature cooling water which is consumed to warm the vehicle, for example. If an air conditioner warms the interior of the vehicle, for example, the compensation value ΔSCA may be calculated on the basis of a set temperature and air flow of the air conditioner and the like.

At Step 10, the ECU 2 determines whether the heat transfer quantity SCA calculated in the above manner is more than the threshold SCAth. If the determination result is “NO”, more specifically if the heat transfer quantity SCA is equal to or less than the threshold SCAth, the ECU 2 determines that the engine 3 is not overcooled. Then, at Step 11, the ECU 2 sets the valve opening flag F_VLV to “1” and opens the introducing valve 73. At Step 12, the ECU 2 operates the electrically powered pump 63 under a predetermined condition, and then terminates the cooling control process.

Under the predetermined condition, the ECU 2 controls the electrically powered pump 63 to continuously operate such that the quantity of high-temperature cooling water introduced to the inhaled gas cooling circuit 60 is equal to the introduction quantity QHi calculated at Step 7. With this control, part of the high-temperature cooling water in the engine cooling circuit 50 is introduced to the inhaled gas cooling circuit 60 through the high-temperature cooling water introducing passage 71, and part of the low-temperature cooling water in the inhaled gas cooling circuit 60 is returned to the engine cooling circuit 50 through the low-temperature cooling water returning passage 72. As a result, the high-temperature cooling water is mixed with the low-temperature cooling water in the inhaled gas cooling circuit 60 whereby the temperature of the low-temperature cooling water increases. This reduces generation of condensate water caused as a result of cooling the inhaled gas with the intercooler 34 to condense vapor contained in the inhaled gas.

If the determination result is “YES” at Step 10, more specifically if the heat transfer quantity SCA is more than the threshold SCAth, the ECU 2 determines that the engine 3 is overcooled. To suppress this overcooling, at Step 13, the ECU 2 operates the electrically powered pump 63 in an intermittent manner, thereby controlling a decrease in temperature of the high-temperature cooling water.

When operating the electrically powered pump 63 in an intermittent manner, the ECU 2 usually selects a stop mode but, as necessary, selects an operation mode instead of the stop mode. In the stop mode, the ECU 2 sets the valve opening flag F_VLV to “0” and stops operating the electrically powered pump 63 while closing the introducing valve 73. When the introducing valve 73 is closed in the stop mode, the high-temperature cooling water is blocked from being introduced to the inhaled gas cooling circuit 60 so that the temperature of the high-temperature cooling water increases. Thus, with the stop mode, overcooling of the engine 3 is controlled appropriately. Moreover, by stopping operating the electrically powered pump 63, an unnecessary operation of the electrically powered pump 63 which may cause overcooling of the engine 3 is suppressed. Thus, with the stop mode, consumption of electric power in the electrically powered pump 63 is reduced.

In the operation mode, the ECU 2 sets the valve opening flag F_VLV to “1” and operates the electrically powered pump 63 while opening the introducing valve 73. The operation mode is selected when the low cooling water temperature TWLo detected by the second water temperature sensor 65 is lower than the preset temperature, more specifically, for example, the ECU 2 determines that the inhaled gas may condense to generate condensate water. In this operation mode, the electrically powered pump 63 operates while the introducing valve 73 is opened. Therefore, the high-temperature cooling water is introduced to the inhaled gas cooling circuit 60 whereby the temperature of the low-temperature cooling water increases. This reduces generation of condensate water caused as a result of cooling and condensing the inhaled gas, even when the engine 3 is overcooled.

Next, a cooling control process in a second embodiment will be described with reference to FIG. 10. The cooling control process in the second embodiment can be performed instead of the cooling control process in the first embodiment which has been described with reference to FIG. 5. In the cooling control process in the second embodiment, different steps are performed when the engine 3 is determined to be overcooled. In the following description, steps in FIG. 10 which are identical to steps in the first embodiment are given the same step numbers and will not be described accordingly.

In this cooling control process, if the determination result is “YES” at Step 10, more specifically if the heat transfer quantity SCA is more than the threshold SCAth, the ECU 2 determines that the engine 3 is overcooled. Then, at Step 21, the ECU 2 sets the valve opening flag F_VLV to “0”, and closes the introducing valve 73. Closing the introducing valve 73 blocks the high-temperature cooling water from being introduced to the inhaled gas cooling circuit 60, increasing the temperature of the high-temperature cooling water. Consequently, the overcooling of the engine 3 is reliably controlled.

At Step 22, the ECU 2 stops operating the electrically powered pump 63. The operations at Steps 21 and 22 suppress the electrically powered pump 63 from operating unnecessarily during overcooling of the engine 3, reducing consumption of electric power in the electrically powered pump 63. Then, at Step 23, the engine 3 controls the electric generator 8 to generate more electric power, and then terminates the cooling control process. Generating more electric power increases a load placed on the engine 3 driving the electric generator 8, thereby helping increase temperature of the high-temperature cooling water. Therefore, the operation at Step 23 controls overcooling of the engine 3 efficiently. Electrical energy generated by the electric generator 8 is stored in the battery. Therefore, lowering of the fuel efficiency which would be caused due to an increase in the electric power is controlled appropriately.

The first and second embodiments described above are exemplary and may be modified or varied in various ways. For example, in the second embodiment, when determining that the engine 3 is overcooled, the ECU 2 both closes the introducing valve 73 at Step 21 and stops operating the electrically powered pump 63 at Step 22. However, the ECU 2 may perform either one of the operations at Steps 21 and 22. Furthermore, after having performed the operations at Steps 21 and 22, the ECU 2 do not necessarily have to control the electric generator 8 to generate more electric power at Step 23. In addition, the ECU 2 may perform the operation at Step 23 when operating the electrically powered pump 63 in an intermittent manner at Step 12 in the first embodiment.

In the first and second embodiments, the ECU 2 calculates the heat transfer quantity SCA, which is the quantity of heat transferred from the engine cooling circuit 50 to the inhaled gas cooling circuit 60, and the threshold SCAth of the heat transfer quantity SCA. Then, the ECU 2 determines whether the engine 3 is overcooled, on the basis of a result of comparing the heat transfer quantity SCA and the threshold SCAth. However, the ECU 2 may determine whether the engine 3 is overcooled, on the basis of another appropriate technique. To give an example, if the high cooling water temperature TWHi detected by the first water temperature sensor 55 is less than a preset value, the ECU 2 may determine that the engine 3 is overcooled. This makes it possible to determine overcooling of the engine 3 accurately. To give another example, the ECU 2 may combine a technique using the heat transfer quantity SCA and the threshold SCAth with a technique using detection results of the first water temperature sensor 55 and the second water temperature sensor 65. This makes it possible to determine overcooling of the engine 3 more accurately.

In the first and second embodiments, the introducing valve 73 has two positions, or fully opened and fully closed positions; however, an introducing valve that has a variable opening may be used instead of the introducing valve 73. In this case, instead of operating the electrically powered pump 63 in an intermittent manner as in the first embodiment or to fully close the introducing valve 73 as in the second embodiment, for example, the ECU 2 may vary (decrease) the opening of the introducing valve in order to adjust (decrease) the quantity of high-temperature cooling water introduced to the inhaled gas cooling circuit 60, namely, in order to adjust (decrease) the quantity of heat transferred to the inhaled gas cooling circuit 60.

The electrically powered pump 63 does not have to operate in an intermittent manner in the first embodiment or to completely stop operating in the second embodiment. Alternatively, the electrically powered pump 63 may feed a smaller quantity of the low-temperature cooling water by lowering its rotation frequency, in order to decrease a rate at which the low-temperature cooling water flows through the inhaled gas cooling circuit 60. The detailed configurations, operations, functions, etc. of the cooling control apparatus 1 in the first and second embodiments are exemplary and may be modified or varied as appropriate within the scope of the claims.

According to a first aspect of the embodiment, a cooling control apparatus for an internal combustion engine cools an internal combustion engine equipped with a supercharger and also cools inhaled gas supplied from the supercharger by using an intercooler. An internal combustion engine cooling circuit includes an internal combustion engine main body, a first radiator, a first cooling water passage, and a first pump. The first cooling water passage is connected to the internal combustion engine main body and to the first radiator. The first cooling water passage allows cooling water to circulate between the internal combustion engine main body and the first radiator. The first pump causes the cooling water to circulate by feeding the cooling water to the first cooling water passage. An inhaled gas cooling circuit includes the intercooler, a second radiator, a second cooling water passage, and a second pump. The second cooling water passage is connected to the intercooler and to the second radiator. The second cooling water passage allows cooling water to circulate between the intercooler and the second radiator. The second pump causes the cooling water to circulate by feeding the cooling water to the second cooling water passage. A cooling water introducing passage is connected to the first cooling water passage and to the second cooling water passage. The cooling water introducing passage allows the cooling water in the internal combustion engine cooling circuit to be introduced to the inhaled gas cooling circuit. An overcooling determination unit determines whether the internal combustion engine is overcooled due to a decrease in temperature of the cooling water in the internal combustion engine cooling circuit. When the overcooling determination unit determines that the internal combustion engine is overcooled, a temperature-decrease controller controls the decrease in the temperature of the cooling water in the internal combustion engine cooling circuit.

The above cooling control apparatus for an internal combustion engine includes cooling circuits for a water-cooled internal combustion engine and for an inhaled gas, namely, an internal combustion engine cooling circuit and an inhaled gas cooling circuit. In the internal combustion engine cooling circuit, the first pump feeds the cooling water to circulate through the first cooling water passage. This cooling water cools the internal combustion engine by removing heat from the internal combustion engine main body and radiates the removed heat through the first radiator. Since the internal combustion engine has a high temperature due to its combustion heat, the cooling water that flows through the internal combustion engine cooling circuit has a relatively high temperature. Hereinafter, this cooling water is referred to as “high-temperature cooling water”. In the inhaled gas cooling circuit, the second pump feeds the cooling water to circulate through the second cooling water passage. When passing through the intercooler, this cooling water cools the inhaled gas supplied and heated by the supercharger by removing heat from the inhaled gas. Then, the cooling water radiates the heat through the second radiator. Since the inhaled gas supplied from the supercharger has a lower temperature than the internal combustion engine, the cooling water that flows through the inhaled gas cooling circuit has a relatively low temperature. Hereinafter, the cooling water is referred to as “low-temperature cooling water”.

The high-temperature cooling water in the internal combustion engine cooling circuit is introduced to the inhaled gas cooling circuit through the cooling water introducing passage connected to both the first cooling water passage and the second cooling water passage. As a result, the high-temperature cooling water is mixed with the low-temperature cooling water. In response to this, heat of the high-temperature cooling water is transferred to the low-temperature cooling water, and the temperature of the low-temperature cooling water thereby increases. This reduces generation of condensate water caused as a result of cooling and condensing the inhaled gas.

The temperature-decrease controller determines whether the internal combustion engine is overcooled. When determining whether the internal combustion engine is overcooled, the temperature-decrease controller controls the decrease in the temperature of the high-temperature cooling water. In this way, the cooling control apparatus appropriately cools the internal combustion engine without inhibiting the internal combustion engine from being warmed. Thus, the cooling control apparatus can appropriately suppress the occurrence of disadvantages, for example, where increased friction in the internal combustion engine decreases output of the internal combustion engine.

According to a second aspect of the embodiment, in addition to the first embodiment, the cooling control apparatus for an internal combustion engine preferably further includes an introducing valve that is disposed in the cooling water introducing passage and that is opened when the cooling water in the internal combustion engine cooling circuit is introduced to the inhaled gas cooling circuit. Furthermore, when the internal combustion engine is determined to be overcooled, the temperature-decrease controller preferably causes the introducing valve to be closed.

As described above, when the internal combustion engine is determined to be overcooled, the temperature-decrease controller preferably causes the introducing valve disposed in the cooling water introducing passage to be closed. This configuration decreases the quantity of high-temperature cooling water introduced from the internal combustion engine cooling circuit to the inhaled gas cooling circuit, thereby decreasing heat transferred from the high-temperature cooling water to the low-temperature cooling water. In this way, the cooling control apparatus can reliably control the decrease in the temperature of the high-temperature cooling water, thereby efficiently suppressing the internal combustion engine from being overcooled.

According to a third aspect of the embodiment, in addition to the first aspect, the second pump preferably includes an electrically powered pump. Furthermore, when the internal combustion engine is determined to be overcooled, the temperature-decrease controller preferably controls the second pump to stop operating or to feed a smaller quantity of cooling water.

As described above, when the internal combustion engine is determined to be overcooled, the temperature-decrease controller preferably controls the electrically powered pump included in the second pump to stop operating or to feed a smaller quantity of low-temperature cooling water. This configuration causes no low-temperature cooling water or a smaller quantity of low-temperature cooling water to flow through the inhaled gas cooling circuit. Since the high-temperature cooling water is inhibited from flowing into the inhaled gas cooling circuit, a smaller quantity of high-temperature cooling water is introduced to the inhaled gas cooling circuit. In this way, the cooling control apparatus can appropriately suppress the internal combustion engine from being overcooled by controlling a decrease in temperature of the high-temperature cooling water. Moreover, by causing no low-temperature cooling water or a smaller quantity of low-temperature cooling water to flow through the inhaled gas cooling circuit, the quantity of heat radiated through the sub-radiator can be decreased.

In general, the internal combustion engine tends to be overcooled in a low-revolution or light-load state where a small quantity of heat is generated by the combustion. In this low-revolution or light-load state, the supercharger supplies the inhaled gas at a low pressure, and thus the inhaled gas does not necessarily have to be cooled. For this reason, when the internal combustion engine is determined to be overcooled, the electrically powered pump preferably stops operating or feeds a smaller quantity of cooling water. This can suppress the electrically powered pump from operating unnecessarily, thereby reducing consumption of electric power in the electrically powered pump.

According to a fourth aspect of the embodiment, in addition to the first aspect, the cooling control apparatus for an internal combustion engine preferably further includes an introducing valve that is disposed in the cooling water introducing passage and that is opened when the cooling water in the internal combustion engine cooling circuit is introduced to the inhaled gas cooling circuit. The second pump preferably includes an electrically powered pump. When the internal combustion engine is determined to be overcooled, the temperature-decrease controller preferably operates, in an intermittent manner, the second pump in a stop mode and in an operation mode that are alternately selected. In the stop mode, the second pump stops its operation and the introducing valve is closed. In the operation mode, the second pump operates and the introducing valve is opened.

As described above, when the internal combustion engine is determined to be overcooled, the electrically powered pump included in the second pump preferably operates in an intermittent manner. This intermittent operation has a stop mode and an operation mode; in the stop mode, the electrically powered pump stops its operation and the introducing valve is closed, and in the operation mode, the electrically powered pump operates and the introducing valve is opened. The stop mode and the operation mode are alternately selected. Closing the introducing valve in the stop mode blocks the high-temperature cooling water from being introduced to the inhaled gas cooling circuit, thereby increasing the temperature of the high-temperature cooling water. This appropriately suppresses the internal combustion engine from being overcooled. Since the electrically powered pump stops operating, the electrically powered pump does not have to operate unnecessarily, making it possible to reduce consumption of electric power in the electrically powered pump.

In the operation mode in which the electrically powered pump operates and the introducing valve is opened, the high-temperature cooling water is introduced to the inhaled gas cooling circuit, thereby increasing the temperature of the low-temperature cooling water. This efficiently reduces generation of condensate water caused as a result of cooling and condensing the inhaled gas, even when the internal combustion engine is overcooled.

According to a fifth aspect of the embodiment, in addition to one of the second to fourth aspects, the internal combustion engine is preferably coupled to an electric generator that generates electrical energy by using the internal combustion engine as an a mechanical power source, and the electrical energy generated by the electric generator is preferably stored in a battery. When the internal combustion engine is determined to be overcooled, the temperature-decrease controller preferably controls the electric generator to generate more electrical energy.

As described above, when the internal combustion engine is determined to be overcooled, the temperature-decrease controller preferably controls the electric generator to generate more electrical energy. Generating more electrical energy increases a load placed on the internal combustion engine driving the electric generator. Then, the internal combustion engine emits a larger quantity of combustion heat, increasing the temperature of the high-temperature cooling water. This effectively suppresses the internal combustion engine from being overcooled. Since electrical energy generated by the electric generator is stored in the battery, lowering of the fuel efficiency which would be caused due to an increase in the electric power is controlled appropriately.

According to a sixth aspect of the embodiment, in addition to one of the first to fifth aspects, the overcooling determination unit preferably determines whether the internal combustion engine is overcooled, on the basis of one or both of a predetermined calculation result and a detection result of a predetermined temperature sensor.

If the overcooling determination unit determines whether the internal combustion engine is overcooled, on the basis of a detection result of a predetermined temperature sensor, the determination can be made accurately. If the overcooling determination unit determines whether the internal combustion engine is overcooled, on the basis of a predetermined calculation result, the determination can be made at a low cost without using any temperature sensor. If the overcooling determination unit determines whether the internal combustion engine is overcooled, on the basis of both a predetermined calculation result and a detection result of a predetermined temperature sensor, the determination can be made more accurately.

Obviously, numerous modifications and variations of the present invention are possible in light of the above teachings. It is therefore to be understood that within the scope of the appended claims, the invention may be practiced otherwise than as specifically described herein.

What is claimed is:

1. A cooling control apparatus for an internal combustion engine which cools an internal combustion engine equipped with a supercharger and which cools inhaled gas supplied from the supercharger by using an intercooler, the cooling control apparatus comprising:
an internal combustion engine cooling circuit including an internal combustion engine main body, a first radiator, a first cooling water passage, and a first pump, the first cooling water passage being connected to the internal combustion engine main body and to the first radiator, the first cooling water passage allowing cooling water to circulate between the internal combustion engine main body and the first radiator, the first pump causing the cooling water to circulate by feeding the cooling water to the first cooling water passage;
an inhaled gas cooling circuit including the intercooler, a second radiator, a second cooling water passage, and a second pump, the second cooling water passage being connected to the intercooler and to the second radiator, the second cooling water passage allowing cooling water to circulate between the intercooler and the second radiator, the second pump causing the cooling water to circulate by feeding the cooling water to the second cooling water passage;
a cooling water introducing passage connected to the first cooling water passage and to the second cooling water passage, the cooling water introducing passage allowing the cooling water in the internal combustion engine cooling circuit to be introduced to the inhaled gas cooling circuit;
an overcooling determination unit determining whether the internal combustion engine is overcooled due to a decrease in temperature of the cooling water in the internal combustion engine cooling circuit; and
a temperature-decrease controller, when the overcooling determination unit determines that the internal combustion engine is overcooled, controlling the decrease in the temperature of the cooling water in the internal combustion engine cooling circuit.

2. The cooling control apparatus for the internal combustion engine according to claim 1, further comprising an introducing valve disposed in the cooling water introducing passage, the introducing valve being opened when the cooling water in the internal combustion engine cooling circuit is introduced to the inhaled gas cooling circuit,
wherein when the internal combustion engine is determined to be overcooled, the temperature-decrease controller causes the introducing valve to be closed.

3. The cooling control apparatus for the internal combustion engine according to claim 1, wherein
the second pump includes an electrically powered pump, and
when the internal combustion engine is determined to be overcooled, the temperature-decrease controller controls the second pump to stop operating or to feed a smaller quantity of cooling water.

4. The cooling control apparatus for the internal combustion engine according to claim 1, further comprising an introducing valve disposed in the cooling water introducing passage, the introducing valve being opened when the cooling water in the internal combustion engine cooling circuit is introduced to the inhaled gas cooling circuit,
wherein the second pump includes an electrically powered pump, and
when the internal combustion engine is determined to be overcooled, the temperature-decrease controller operates, in an intermittent manner, the second pump in a stop mode and in an operation mode that are alternately selected, in the stop mode the second pump stopping its operation and the introducing valve being closed, in the operation mode the second pump operating and the introducing valve being opened.

5. The cooling control apparatus for the internal combustion engine according to claim 2, wherein
the internal combustion engine is coupled to an electric generator that generates electrical energy by using the internal combustion engine as an a mechanical power source, and the electrical energy generated by the electric generator is stored in a battery, and
when the internal combustion engine is determined to be overcooled, the temperature-decrease controller controls the electric generator to generate more electrical energy.

6. The cooling control apparatus for the internal combustion engine according to claim 1, wherein
the overcooling determination unit determines whether the internal combustion engine is overcooled, on the basis of one or both of a predetermined calculation result and a detection result of a predetermined temperature sensor.

7. A cooling control apparatus for an internal combustion engine with a supercharger, comprising:
an internal combustion engine cooling circuit comprising:
a first radiator;
a first cooling water passage connecting the first radiator to a main body of the internal combustion engine; and
a first pump provided in the first cooling water passage to circulate cooling water in the internal combustion engine cooling circuit;
an inhaled gas cooling circuit comprising:
an intercooler to cool inhaled gas supplied from the supercharger;
a second radiator;
a second cooling water passage connecting the second radiator to the intercooler; and
a second pump provided in the second cooling water passage to circulate cooling water in the inhaled gas cooling circuit;
a cooling water introducing passage connecting the first cooling water passage and the second cooling water passage, the cooling water flowing from the internal combustion engine cooling circuit to the inhaled gas cooling circuit via the cooling water introducing passage;
an overcooling determination device to determine whether the internal combustion engine is overcooled based on a decrease in temperature of the cooling water in the internal combustion engine cooling circuit; and
a temperature-decrease controller to control an amount of the cooling water flowing from the internal combustion engine cooling circuit to the inhaled gas cooling circuit via the cooling water introducing passage to control the decrease in the temperature of the cooling water in the internal combustion engine cooling circuit in a case where the overcooling determination device determines that the internal combustion engine is overcooled.

8. The cooling control apparatus according to claim 7, further comprising an introducing valve disposed in the cooling water introducing passage, the introducing valve being opened in a case where the cooling water in the internal combustion engine cooling circuit flows to the inhaled gas cooling circuit,
wherein the temperature-decrease controller controls the introducing valve to be closed in a case where the internal combustion engine is determined to be overcooled.

9. The cooling control apparatus according to claim 7, wherein
the second pump includes an electrically powered pump, and
the temperature-decrease controller controls the second pump to stop operating or to feed a smaller quantity of cooling water in a case where the internal combustion engine is determined to be overcooled.

10. The cooling control apparatus according to claim 7, further comprising an introducing valve disposed in the cooling water introducing passage, the introducing valve being opened in a case where the cooling water in the internal combustion engine cooling circuit flows to the inhaled gas cooling circuit,
wherein the second pump includes an electrically powered pump, and
in a case where the internal combustion engine is determined to be overcooled, the temperature-decrease controller operates, in an intermittent manner, the second pump in a stop mode and in an operation mode that are alternately selected, in the stop mode the second pump stopping operation and the introducing valve being closed, in the operation mode the second pump operating and the introducing valve being opened.

11. The cooling control apparatus according to claim 8, wherein
the internal combustion engine is coupled to an electric generator that generates electrical energy by using the internal combustion engine as an a mechanical power source, and the electrical energy generated by the electric generator is stored in a battery, and
the temperature-decrease controller controls the electric generator to generate more electrical energy in a case where the internal combustion engine is determined to be overcooled.

12. The cooling control apparatus according to claim 7, wherein
the overcooling determination device determines whether the internal combustion engine is overcooled based on one or both of a predetermined calculation result and a detection result of a predetermined temperature sensor.

13. An internal combustion engine comprising:
a main body;
a supercharger;
an internal combustion engine cooling circuit comprising:
a first radiator;
a first cooling water passage connecting the first radiator to the main body of the internal combustion engine; and
a first pump provided in the first cooling water passage to circulate cooling water in the internal combustion engine cooling circuit;
an inhaled gas cooling circuit comprising:
an intercooler to cool inhaled gas supplied from the supercharger;
a second radiator;
a second cooling water passage connecting the second radiator to the intercooler; and
a second pump provided in the second cooling water passage to circulate cooling water in the inhaled gas cooling circuit;
a cooling water introducing passage connecting the first cooling water passage and the second cooling water passage, the cooling water flowing from the internal combustion engine cooling circuit to the inhaled gas cooling circuit via the cooling water introducing passage;
an overcooling determination device to determine whether the internal combustion engine is overcooled based on a decrease in temperature of the cooling water in the internal combustion engine cooling circuit; and
a temperature-decrease controller to control an amount of the cooling water flowing from the internal combustion engine cooling circuit to the inhaled gas cooling circuit via the cooling water introducing passage to control the decrease in the temperature of the cooling water in the internal combustion engine cooling circuit in a case where the overcooling determination device determines that the internal combustion engine is overcooled.
